(19) United States
(12) Patent Application Publication
(10) Pub. No.: US 2002/0083469 A1
(43) Pub. Date: Jun. 27, 2002

(54) Embedding re-usable object-based product information in audiovisual programs for non-intrusive, viewer driven usage

(75) Inventors: Sylvie Jeannin, New York, NY (US); Grace Chang, Richardson, TX (US); Gandhimathi Vaithilingam, Mountainview, CA (US)

Correspondence Address: Michael C. Stuart, Esq., Cohen, Pontani, Lieberman & Pavane, 551 Fifth Avenue, Suite 1210, New York, NY, 10176, US

(73) Assignee: Koninklijke Philips Electronics N.V.

(21) Appl. No.: 09/745,339

(22) Filed: Dec. 22, 2000

(51) Int. Cl. H04N 7/173; G06F 3/00; H04N 5/445

(52) U.S. Cl. 725/135; 725/112; 725/42

(57) ABSTRACT

A system and method for non-intrusively embedding a multimedia advertisement associated with an object in an audiovisual program provided by one of various sources. The advertisement may be accessed and extracted from the program by pointing and clicking on the object while the object is displayed. A summary of advertisements may thereby be created. The accessed advertisements may be bookmarked or stored to create the summary. A user may create a profile of preferred types(s) of advertisements to filter out the display of advertisements for undesired types of advertisements.

### BACKGROUND OF THE INVENTION

1. Field of the Invention

This invention relates to a system and method of including multimedia advertisements non-intrusively in audiovisual programs so that a viewer may view an advertisement and re-use the advertisement or information therein.

2. Description of the Related Art

There are a number of existing methods for including advertisements in audiovisual programs. One such method is the well-known and conventional placement of audiovisual commercials between and during television entertainment programs. This method has the advantage of being able to convey to a potential consumer a great deal of information, but requires that the entertainment program(s) be completely interrupted. Such constant interruptions are intrusive as well as annoying to the viewer. Moreover, the commercials can be skipped by the viewer, either by changing channels, leaving the room, or otherwise disregarding them or, if the program is recorded, by fast forwarding through the commercials.

A second method of associating advertisements with audio-visual programs is to place advertising panels on the borders of a sports field where the panels are visible during televised sports programs. Similarly, newer image processing techniques allow a program supplier to superimpose advertisements onto a virtual image panel that does not physically exist at the location in the image where it appears, i.e. at the sports field. This second method thereby enables the promotion of products or brands without interrupting or stopping the program. However, this type of advertising is limited to sports programs and allows the display of only a few words per product. Moreover, although the advertisements can be tailored to the type of program in which they appear (e.g., razors for car racing programs), they cannot take into account a user profile or a current interest of the user.

A third method of associating advertisements with audiovisual programs is to incorporate products into the program itself, such as by having an actor use the product or by displaying the product in the program background. For example, an actor might stand next to a Philips® television in one scene in a movie. This enables the promotion of products or brands without stopping the program and allows viewers to be selectively targeted by choosing in which type of programs the products should be included. However, this method does not provide information about the promoted product and cannot take into account a user profile or a current interest of the user.

A fourth method of associating advertisements with audiovisual programs is to compress the area in which a program is displayed on a television and to place advertisements along the margins of the program. Or an advertisement may be placed in a corner of the television screen.

A fifth more recently introduced method used in Web TV, displays one or more hyperlinks on the edges of a television screen. The hyperlink(s) are generally related to the program generally or to particular products displayed on the television screen. These hyperlinks are manually inserted at certain points in the program and are associated with portions of the program, but are not coded on a per-object basis. A viewer can point to and click on one of these hyperlinks to visit a Web site related to the product. This method of advertising is intrusive and is limited to the display of one or two links so as not to block the display of video.

An approach analogous to the use of hyperlinks has been developed by MIT Media Lab which has named its concept Hypersoap. In this concept, a viewer can interactively click with a mouse or an enhanced remote control in a particular area of a display containing an object during the playing of digital video to get textual information for the particular object. Portions (or regions) of the screen containing the items must be delineated by the author of the video such that when a viewer selects a particular delineated portion of the screen, an action occurs, such as the display of information relevant for that portion of the screen is presented over the images on the screen. The author must redelineate the portions of the screen for each scene change or each time an object enters or exits a scene. Depending on how it is set to operate, in one mode, the Hypersoap system waits for an appropriate point to interrupt the video and displays a separate screen with a picture of the product and an associated text box. In another mode, an abbreviated information box might appear immediately without pausing the video and then can fade away after a brief period of time.

The Hypersoap system suffers from a number of limitations. First, when the user clicks on an object, the product information is available only to be seen on the screen; it cannot be downloaded and stored separately or otherwise reused in other applications. Second, the product information available when the user clicks on an object is only textual. Third, there is no interaction with the viewer's profile to filter out only the advertisements of interest to the viewer. Fourth, there is no summary, visual or otherwise, of the advertisements available on a certain frame. Only a textual summary of objects selected during the viewing of the video is shown.

### SUMMARY OF THE INVENTION

It is an object of the invention to link multimedia advertisements to objects in a video stream, including an audiovisual program, where the advertisements are non-intrusive and hidden from view when viewing the video stream unless accessed by a user.

It is a further object of the invention to be able to extract information in the advertisement for various purposes, such as the creation of a diary or catalog and to conduct an electronic search using the extracted information.

It is a further object of the invention to enable the creation of a user profile by a viewer to specify the type of advertisements in which the viewer is interested.

In accordance with these objectives, a system and method is provided for accessing a multimedia advertisement linked with a video object. The advertisement is linked to the video object such that when the video object is displayed as part of the video stream the advertisement may be accessed (i.e. “activated”) by a viewer. (The term “video stream” as used herein includes any video stream, including a video signal within an audiovisual program or within any other type of multimedia program.) Thus, the advertisement is non-intrusive and does not interrupt the video stream. Further, it appears to the viewer that the advertisement is embedded in the video stream. When the video object is displayed, the viewer can access the advertisement, thereby causing the advertisement to be displayed in a multimedia format. One way of accessing the advertisement is to use a pointing device to point to and click on the video object. In order for the video object to be selectable independently of any other video objects, the video object must be in some manner separately delineated within the video stream.

The advertisement comprises data such as product information, vendor information, and/or purchasing information that enables the purchase of the video object. After accessing the advertisement, which causes the advertisement to be displayed, at least a portion of the advertisement data may be extracted and stored in a data file separate from the video stream. The extracted data may comprise information that is searchable. This information can be fed to a search engine for performing a search, such as a search over the Internet for information regarding products related to the displayed video object. The displayed advertisement linked to the video object may be bookmarked without necessarily extracting advertisement data.

The video stream may be composed of more than one video object. One or more of these video objects may have advertisements linked to them. A summary of advertisements in the video stream may be presented. The summary may include all advertisements that are available, only those that are viewed to create a personalized diary, and/or only those that are marked to be included in the summary to create a catalog.

A user profile can be created by the viewer to indicate advertisements of a type(s) in which the viewer is interested. The alert may comprise an indicator such as icon that appears on the display or a sidebar with similar information. Alternatively or in addition, the user profile may be used to download for viewing only those advertisements that are of the indicated type(s).

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a block diagram of an embodiment of the system on which the present invention may be implemented;

FIG. 2 is a block diagram of an embodiment of a viewing device on which the audiovisual program may be viewed and data extracted and reused;

FIG. 3A is a flow chart depicting the steps relating to the authoring and transmission of an audiovisual program that can be used with this program according to one embodiment of the invention;

FIG. 3B is a flow chart of the steps relating to the viewing of the audiovisual program and the extraction and reuse of the embedded advertisement according to one embodiment of the invention;

FIG. 4 depicts a sample frame of an audiovisual program in which the advertisement is visually embedded;

FIG. 5 depicts a sample information screen comprising an advertisement that may be displayed upon clicking on an object in the frame of FIG. 4;

FIG. 6 depicts a sample user profile screen for discriminating whether or not certain types of advertisements are desired by a user;

FIG. 7 depicts a sample diary of advertisements that a user of the invention may create by clicking on various objects in the audiovisual program associated with advertisements;

FIG. 8 depicts an example of a multi-level summary of an audiovisual program, including advertisement and other program information prepared in accordance with one embodiment of the invention; and

FIG. 9 depicts a video image that includes multiple advertisement panels along the side of a tennis court.

### DETAILED DESCRIPTION OF THE PRESENTLY PREFERRED EMBODIMENTS

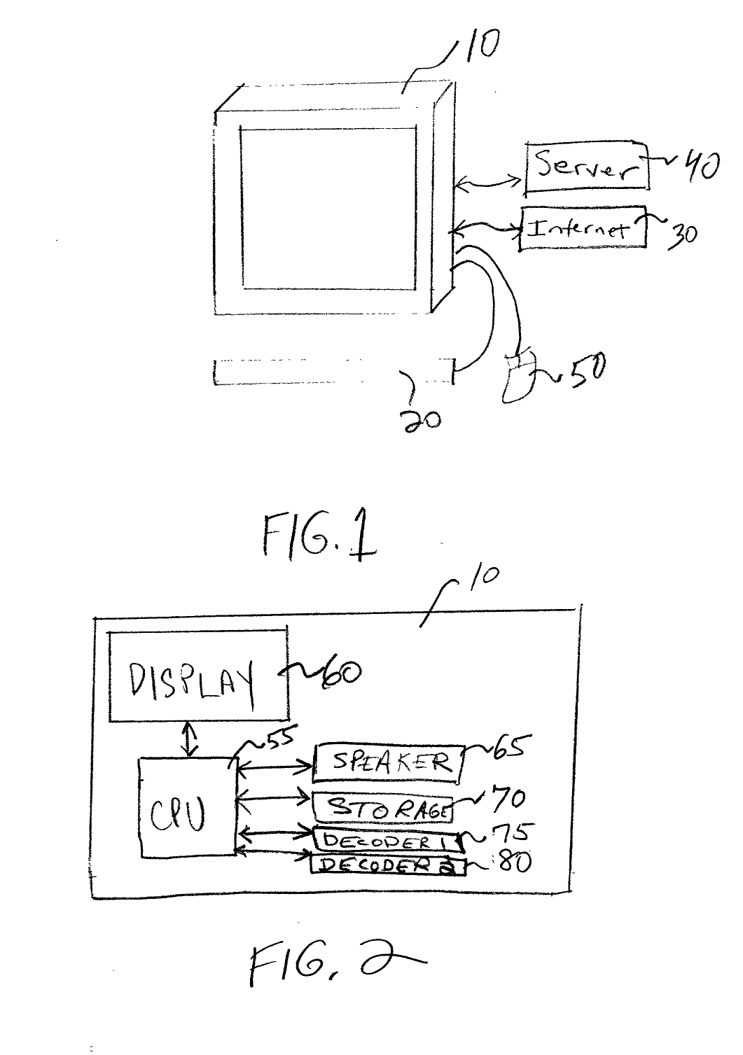

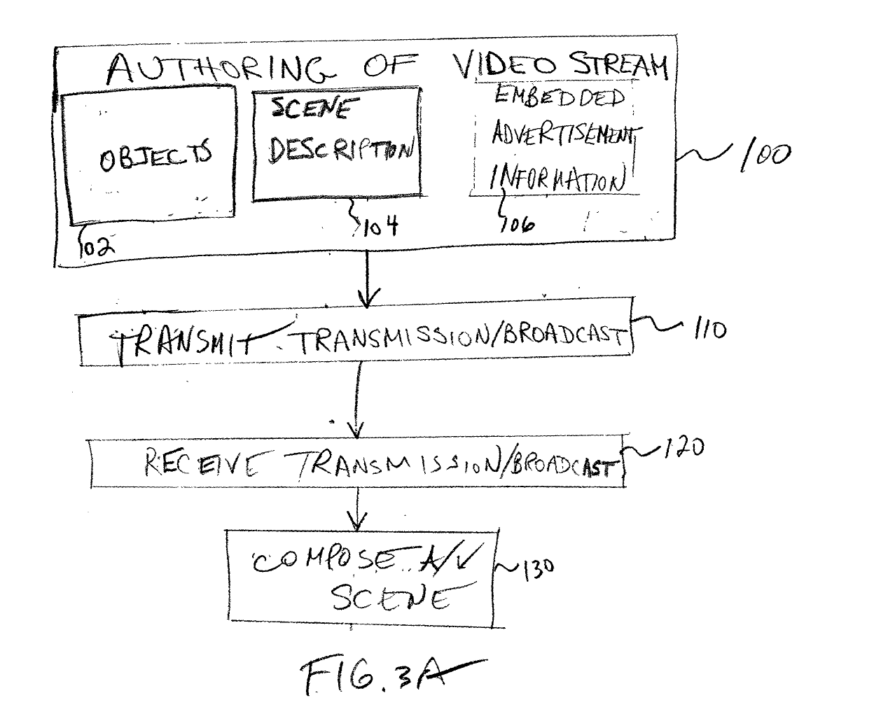

FIG. 1 shows a system according to one embodiment for implementing the present invention. Audiovisual programs comprising one or more scenes, each having a sequence of video frames, are supplied to a viewing device 10 such as a set top box as a video stream. The video stream may be supplied in any of various different contexts and supporting formats. For example, the video stream may be supplied as a conventional broadcast like a television broadcast, supplied on a storage medium like a VHS tape or a digital versatile disc (DVD) for playing on a player device 20, or streaming video downloaded from the Internet 30 or a network server 40. Within the video stream are separately encoded video objects or more simply “objects”, each of which may be independently linked to an advertisement. A pointing device 50, such as a mouse, may be used to point to and click on an object displayed on viewing device 10. As shown in FIG. 2, viewing device 10 has a central processing unit 55 for carrying out the operations of the system, a display 60, a speaker 65, a data storage element 70 for storing a user profile and/or information extracted from various advertisements, a first decoder 75 for decoding the video stream supplied to viewing device 10, and a second decoder 80 for decoding advertisements linked to the objects in the audiovisual program.

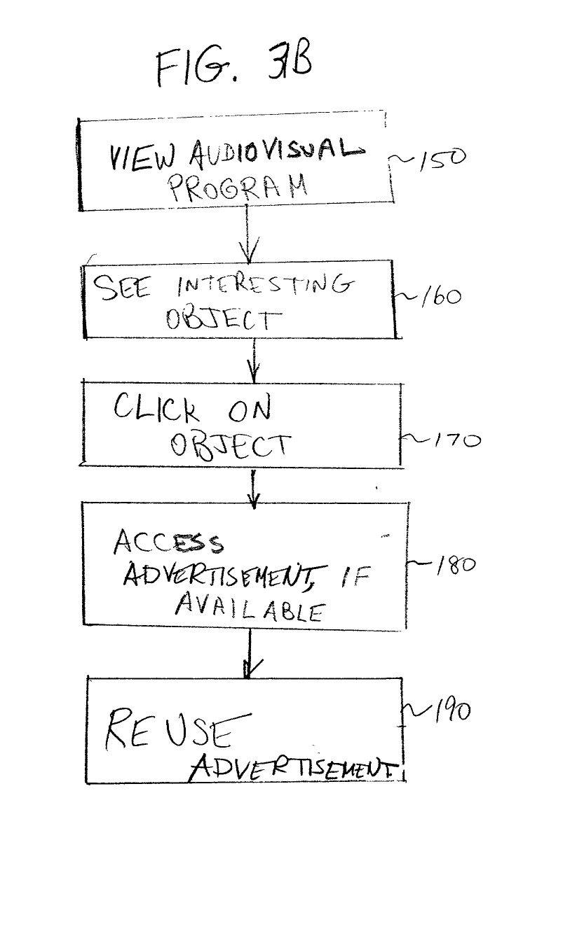

Referring to FIG. 3A, at step 100, an object-based video coding scheme may be used to author the program in which diverse objects are “isolated” in their scenes in order to enable the invention. One such object-based coding scheme is provided by the MPEG-4 standard of the Moving Picture Experts Group (MPEG) of the International Standards Organization (ISO). In MPEG-4, each of video objects 102, including objects such as animated text, video, and still images for a particular scene are separately coded. A scene description 104 details how the objects 102 should be combined for display within the frames of a particular scene. A multimedia advertisement 106 for an object in a scene may include various forms of data, such as images, graphic overlays, text, hyperlinks, and audiovisual clips, that are recorded in a format agreed to in advance by various parties such as the advertisers, broadcasters, the videotape and DVD producers, and manufacturers of any devices used to realize the invention so that the advertisement 106 may be properly processed upon receipt.

Multimedia advertisement 106 may be linked to the object by any appropriate method and is generally encoded separately from the rest of the audiovisual program. MPEG-4's binary format for scenes (BIFS) may be used to supply the link between multimedia advertisement 106 and a related object. BIFS provide a standardized syntax to describe an “object node” or set of data that characterizes the object with which the object node is associated. Included within the set of data in the object node for an object may be a multimedia description, such as advertisement 106, created using ISO's MPEG-7 standard (or the variant of that standard used by the TV Anytime Forum consortium working to create standards for metadata). Thus, the MPEG-7-encoded advertisement is linked to the object via the MPEG-7 “hook” provided by MPEG-4's binary format for scenes (BIFS) in the object node. The format chosen for creating advertisement 106 itself may be for example the extensible markup language (e.g. XML), which is the language of MPEG-7, or a data structure in another existing language. An advertisement 106 may have multiple fields and one of those fields may identify the type of information content contained therein, like specifications, purchasing information, and other product information for the product represented by the object.

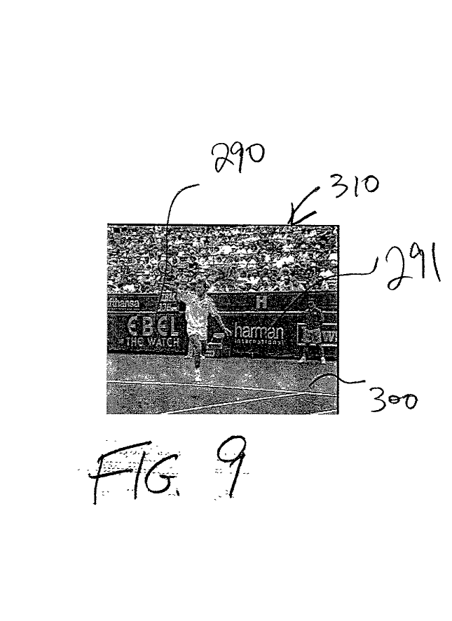

Not all objects in the program are necessarily attached to an advertisement. For those that are attached, an object in a scene may be attached to an advertisement generally independently of another object's attachment to a second advertisement. Objects to be embedded in this manner include objects appearing in the audiovisual program, such as real-world or virtual objects, logos that appear in the program, and advertising panels like those that appear along the sides of sport areas on which actual advertisements are shown. (See e.g. multiple panels 290, 291 placed alongside a tennis court 300 in the image 310 shown in FIG. 9.)

The group of advertisements linked to objects in a particular audiovisual program are generally stored together separate from the audiovisual program. The advertisements are only viewable by the viewer upon viewer demand and in that sense the advertisements are considered to be embedded. Ultimately, when the audiovisual program is played, the linked advertisements may be streamed simultaneously to viewing device 10 along with the audiovisual program by player device 20, or stored separately and linked to the program and streamed (where the advertisements are not stored locally) or displayed (where the advertisement are already stored locally) upon demand.

An alternative technique, other than an object-based coding scheme like the MPEG-4 scheme, may be used for linking an object with an advertisement at step 100. For example, rather than coding by outlines of the object, an object may be identified by using a graphical overlay of a frame and denoting certain regions of the frame as corresponding to the object of interest beneath the graphical overlay such that clicking within a particular region would cause the viewing of any description information associated with that region.

In operation, as depicted in FIG. 3A, the audiovisual program with embedded advertisements 106 is supplied as a signal, whether broadcast, played on player device 20, supplied over the Internet 30, network server 40, or otherwise supplied (step 110) to viewing device 10 where it is received (step 120) and composed into an audiovisual program having one or more scenes (step 130).

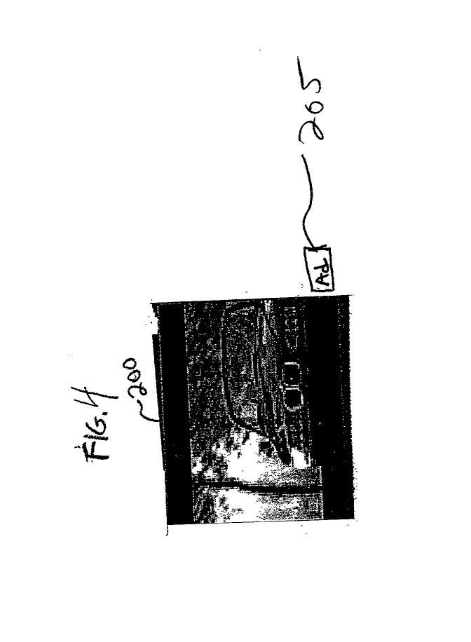

Referring to FIG. 3B, a user of the system (a viewer) views the audiovisual program that contains the embedded object at step 150. The embedded advertisement, which generally comprises only visual data but may also comprise audio and other types of data, is typically not displayed until specifically requested to be displayed. At step 160, when the viewer sees an object of interest about which he wishes to have additional information, such as for example the frame 200 shown in FIG. 4 that displays a car with trees in the background, the viewer may point to and click on the object of interest with a pointer device 50, such as with mouse (step 170). The system then checks whether or not there is an advertisement 106 for the selected object, and if there is such an ad, the user's click causes the information about the object to be accessed and displayed on display 60 (step 180). The viewer may be informed during the viewing of the program that in fact there is an advertisement linked to an object without having to check whether or not there is such an advertisement by the possible display of an indicator such as an icon 205 that pops up on the side of display 60 when the linked object is visible on display 60 or a small side bar on the side of display 60 that textually indicates that an advertisement is available for the displayed object. Where a user profile specifies that the viewer is only interested in a particular type of advertisement, the icon may only appear for the specified type of advertisement.

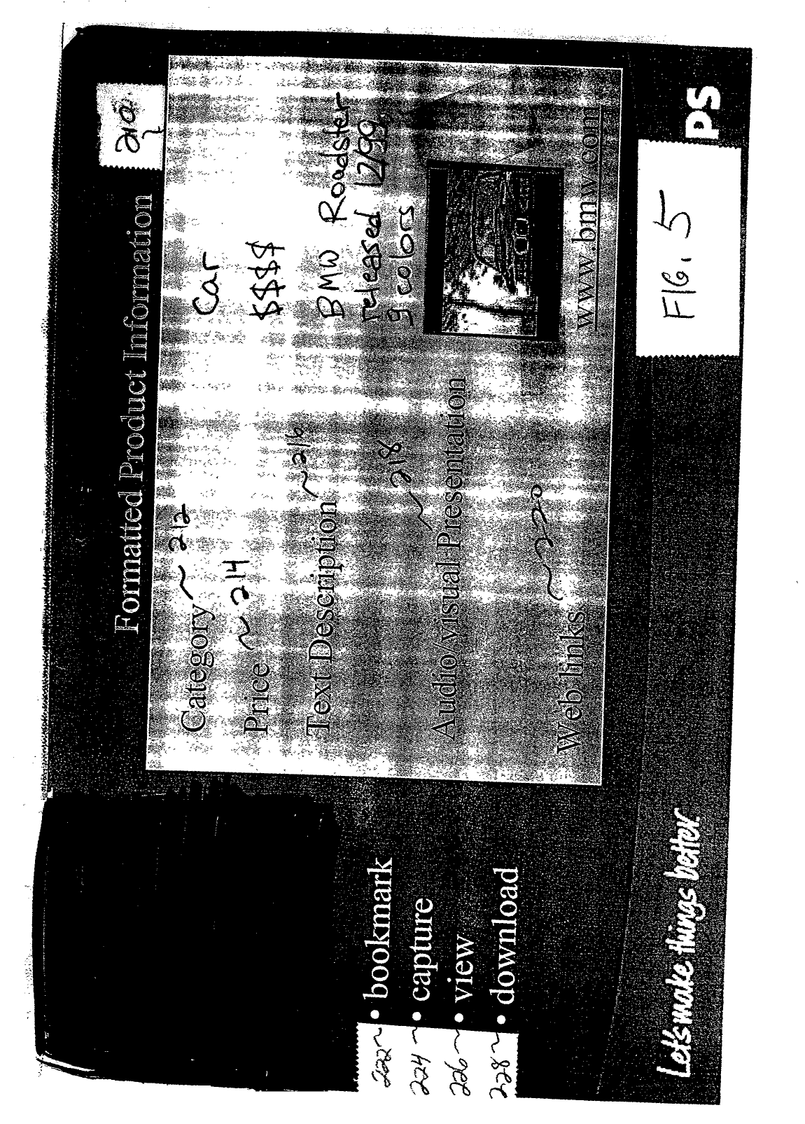

An example of the displayed advertisement/product information which may be displayed in information window 210 is shown in FIG. 5. In the illustrated example, information provided includes metadata about the category 212 of the selected object, its price 214, a text description 216, a thumbnail image of the object of interest 218, and a link 220 to a pertinent Internet Web site where more information about the object is available. Other information could also be provided in window 210 including metadata such as vendor/manufacturer information, an audiovisual demonstration such as a commercial, and any other relevant multimedia data. Because the embedded object information is associated with the object and not the entire frame, at step 190, the user can access and extract the product information, and “reuse” the extracted information in one of various ways.

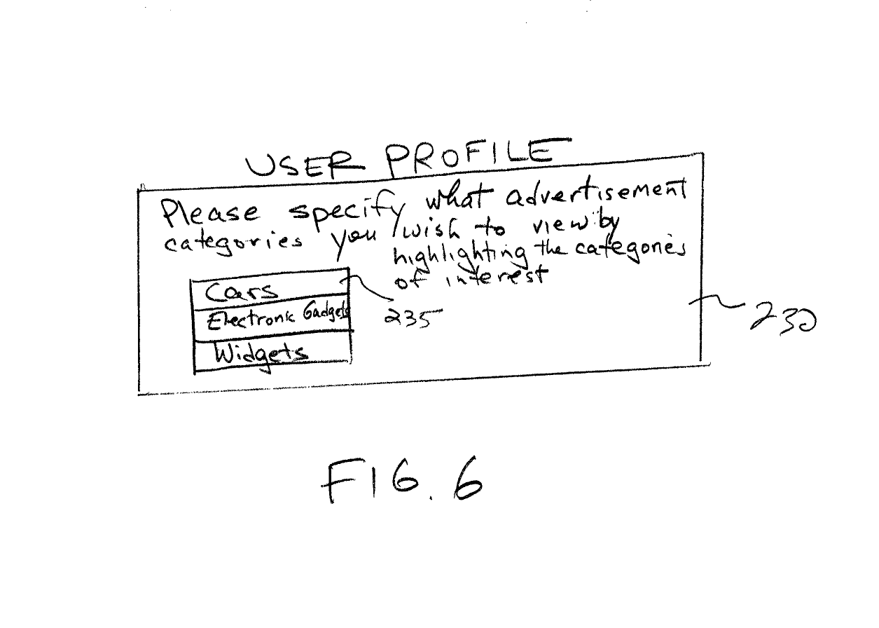

A user profile 230 as shown in FIG. 6 may be created to permit the viewer to specify the types of objects that he wishes to view or be informed about. The viewer may, for example, wish to review advertisements about cars but not about electronic gadgets. In this case, the viewer would highlight the cars category 235 in FIG. 6, as an example. Using the user profile 230, where an audiovisual program displays cars and electronic gadgets and has advertisements for both of these types of objects, and where the viewer is to be notified of the availability of the advertisement, the viewer need only be notified about the car advertisements but not the advertisements associated with electronic gadgets. Or, as another example, where the audiovisual program is downloaded from Web site 30 the user profile can be used to skip downloading irrelevant advertisements. Certain limited amounts of information may be compiled by the advertisers from the user profiles to insure that the advertisements that are downloaded are being viewed by a target audience that is truly interested in these advertisements and that their advertising money is being wisely spent. The user profile 230 should preferably share the same ontology (i.e. vocabulary) as the ontology of the advertisement format so that it is easy to instruct the system to carry out the viewer's instructions.

At step 190, the advertisement 106 is “reused” in one of various ways. In a first application, a user can extract a desired advertisement and reuse the information therein to create a summary 240 of advertisements. Summary 240 may be for example a personalized product diary, which comprises a personalized summary of advertisements that have been viewed. This can be done by pointing to and clicking on a “capture” command tab 224 as shown in FIG. 5. Another means of creating the diary is to point and click on a “Bookmark” command tab 22 on display 60 that creates a Bookmark to the advertisement and create a file of bookmarks to be stored in data storage 70. However, if information is only bookmarked, the source of the audiovisual program, such as the medium on which it is stored, must be available in order to retrieve the advertisement in the future. The diary, however created, can be used for any purpose such as a personal holiday or gift catalog of interesting things to buy in the near future.

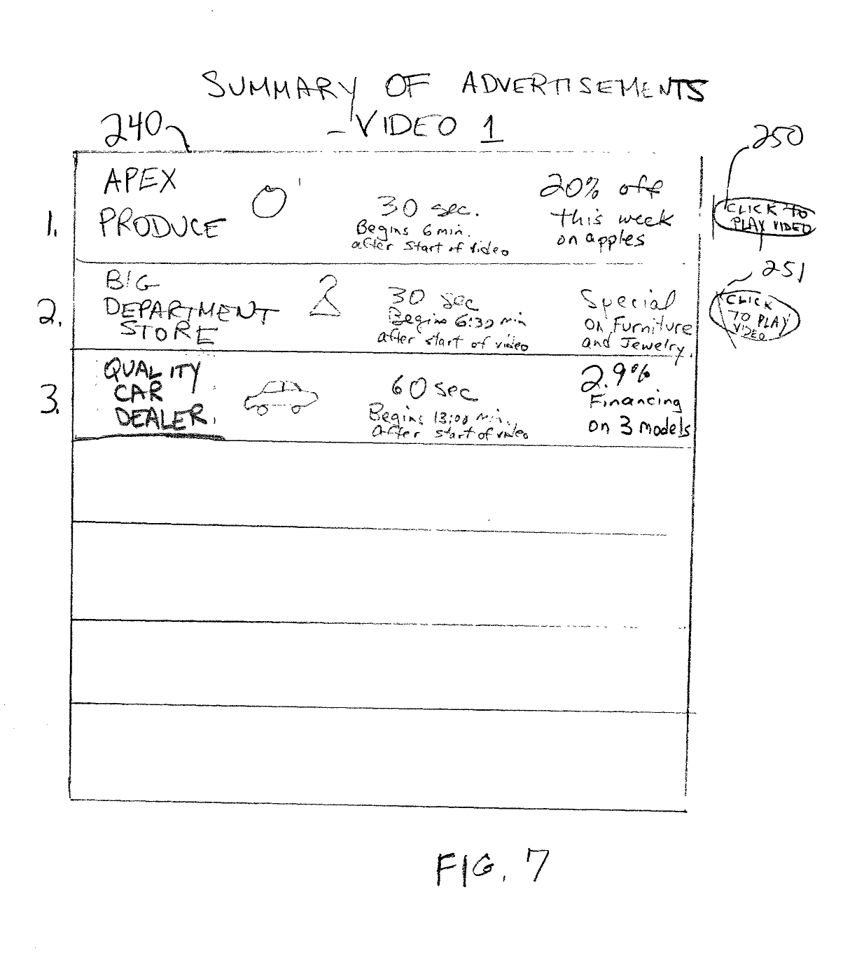

In another application, for example, the advertisement can be “reused” to create a summary of the advertisements associated with the audiovisual program, or a summary of the advertisements that either fit or do not fit a specified user profile. For example, this type of summary can be displayed at the beginning or end of an audiovisual program, if desired. An advertiser can use this summary to monitor advertisements and collect revenue for the advertisements. Alternatively, at the viewer's discretion, a visual summary of all of the advertised products currently on the screen can be displayed. This latter alternative allows the viewer to undertake impulse shopping by selecting an object of interest from various displayed objects. Among other functions that are enabled by creating the summary, icons 250, 251 may be provided next to each object in the summary that takes a viewer to a point in the audiovisual program at which the object linked to the advertisement is displayed. Summary 240 in FIG. 7 could represent any of these or other types of summaries.

In a third possible application for reusing the advertisement information, the features of the advertisement such as keywords can extracted and fed automatically to a search engine on the Web to find various types of information such as other similar products, to compare the price of the product from different vendors, etc.

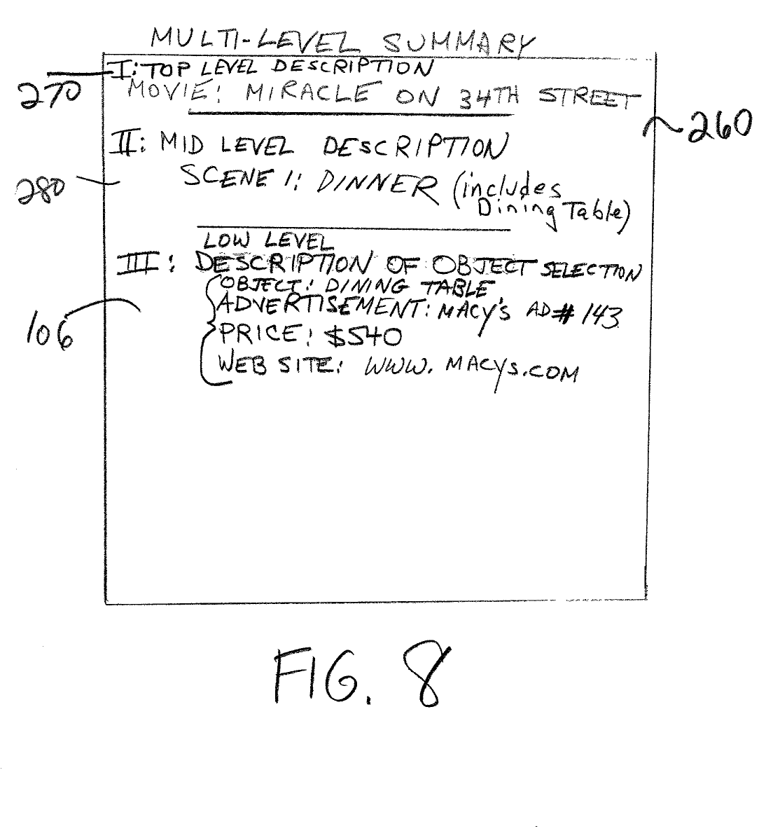

A summary of advertisement information 106 can be included within a broader multi-level summary 260 of the audiovisual program that may include various other levels of information about the audiovisual program besides advertisement information 106. An example of a multi-level summary 260 is shown in FIG. 8. At one such level 270, for example, information may also be provided to describe an entire program, a long or short sequence of frames, or a scene. For example, a movie on a DVD may have an associated content description that includes high level metadata (e.g. title (Miracle on 34^{th} Street), cast, genre of movie, etc.), an audiovisual summary of the movie, detailed descriptions of selected scenes (a mid-level description 280) such as events occurring in those scenes, and, at a lower level, a description of the advertisement information 106. The multilevel content description may also include text annotation such as the audio transcript of the movie. As with the object description information 106, the information can be attached in any manner to the program, sequence, or scene and synchronized to the content to be streamed simultaneously, or stored separately and linked to it. In one special circumstance, where an audiovisual program is completely related only to one object, there will be only one level of information required to describe the object and the entire program.

As is evident from the above description, the structured interface provided by the object description information and any other levels of program description offers additional functionality and enables many new modes of interaction with the linked content. The diary and summary permit personalized visualization and browsing of the content by summary or by highlights of the viewer interest points. Beyond that, it allows the user to search for content having similar features to that of a given audiovisual program. Similarly, the program and content description can be linked to a user profile description sharing the same ontology for filtering in or out advertisements and program selection. In addition to the various above-described benefits of the invention, other benefits of embedding advertisements as metadata include the ability to monitor advertisements and store advertisements digitally at a lower cost (because the standardization of the linking of an object to an advertisement will ultimately result in the creation of lower cost tools for this purpose).

Thus, while there have shown and described and pointed out fundamental novel features of the invention as applied to a preferred embodiment thereof, it will be understood that various omissions and substitutions and changes in the form and details of the system and method illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

What is claimed is:

1. A method of accessing a multimedia advertisement linked with a video object in a video stream, the method comprising:
linking a multimedia advertisement to a video object in a video stream such that the advertisement is not displayed as part of the video stream without being accessed by a viewer of the video stream;
displaying the video object on a display; and
accessing, upon viewer request, the advertisement linked to the object while the object is displayed, thereby causing the advertisement to be displayed in a multimedia format on the display.

2. The method of claim 1, wherein the step of accessing the advertisement comprises pointing to the video object using a pointing device, and clicking on the video object.

3. The method of claim 1, further comprising delineating the video object before linking the advertisement to the video object such that the video object is selectable independently of any other video objects in the video stream.

4. The method of claim 1, wherein the advertisement comprises data and the method further comprises extracting at least a portion of the data in the displayed advertisement after the advertisement is accessed, and placing the extracted data in a data file separate from the video stream.

5. The method of claim 1, wherein the video stream comprises a second object linked to a second advertisement, the method further comprising preparing a summary of at least the first and second advertisements.

6. The method of claim 5, further comprising selecting an advertisement from the prepared summary, and extracting purchasing information from the advertisement to enable the purchase of the video object linked to the advertisement.

7. The method of claim 1, further comprising preparing a summary of the video stream comprising information, other than the advertisement, that is descriptive of the video stream.

8. The method of claim 1, further comprising extracting searchable information from the displayed advertisement after the advertisement is accessed, and feeding the searchable information into a search engine to perform a search.

9. The method of claim 1, further comprising bookmarking the displayed advertisement to create a bookmark to the advertisement.

10. The method of claim 1, further comprising creating a user profile for the viewer indicating a type of advertisement of which the viewer wishes to be aware, and alerting the viewer when the object is linked to the indicated type of advertisement.

11. The method of claim 1, further comprising creating a user profile for the viewer indicating a type of advertisement to which the viewer wishes to have access, downloading the video stream before displaying the video object on the display, and only downloading the advertisement if the advertisement is of the indicated type.

12. A system for accessing a multimedia advertisement linked to a video stream comprising:
a video stream comprising a video object to be displayed;
a multimedia advertisement linked to the video object, the advertisement being displayed only upon viewer request;
a display for displaying the video stream; and
means for accessing the advertisement while the object is displayed during the displaying of the video stream to cause the advertisement to be displayed in a multimedia format.

13. The system of claim 12, wherein the means for accessing the advertisement comprises a pointing device for selecting the video object.

14. The system of claim 12, wherein the advertisement comprises data, and the system further comprises means for extracting at least a portion of the data after the advertisement is accessed, and a data file separate from the video stream comprising the extracted data.

15. The system of claim 12, further comprising: a second object, a second advertisement linked to the second object, and a summary of at least the first and second advertisements.

16. The system of claim 12, wherein the advertisement comprises searchable information, and the system further comprises means for extracting the searchable information from the displayed advertisement after the advertisement is accessed, and means for feeding the searchable information into a search engine to perform a search.

17. The system of claim 12, further comprising means for bookmarking the displayed advertisement to create a bookmark to the advertisement.

18. The system of claim 12, further comprising a user profile for the viewer, indicating a type of advertisement of which the viewer wishes to be aware.

19. The system of claim 12, further comprising mean for preparing a summary of the video stream comprising information, other than the advertisement, that is descriptive of the video stream.
